(19) United States
(12) Patent Application Publication
(10) Pub. No.: US 2008/0255986 A1
(43) Pub. Date: Oct. 16, 2008

(54) Targeting an Individual Customer for a Credit Card Promotion at a Point of Sale

(75) Inventors: Mark Scarborough, Chicago, IL (US); Hoan Wagner, Chicago, IL (US); Jerry Young, Chicago, IL (US); Jonas Ng, Chicago, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Discover Financial Services LLC, Riverwoods, IL (US)

(21) Appl. No.: 11/734,772

(22) Filed: Apr. 12, 2007

(51) Int. Cl. G06Q 40/00

(52) U.S. Cl. 705/38

(57) ABSTRACT

Techniques are described for targeting customers with offers for pre-approved credit. The techniques can be employed while the customer is engaged in a business transaction at a merchant's point-of-sale by pre-screening for creditworthiness using basic customer information known to the merchant. The pre-screening can be performed on behalf of a single lender or in a cascading fashion on behalf of multiple lenders should the customer fail initial pre-screens. Additionally, techniques are described for using a cascading approach on customer-initiated credit applications, such that an applicant declined credit from one lender is automatically considered for credit from another lender via an arrangement between the lenders.

### FIELD OF THE INVENTION

This invention relates generally to the field of credit applications, and more particularly to a process for allowing a single customer to be pre-screened and offered applications on behalf of one or more cooperating lenders at a point-of-sale.

### BACKGROUND OF THE INVENTION

Modern day consumers are often presented with a dizzying array of offers for credit cards from a variety of lenders. Many of these offers take the form of direct mailings to one's home and require the consumer to wade through individual offers and promotions in order to find a card with terms most favorable to him. Furthermore, these offers often require the consumer to provide additional information and return a form to a lender, thus complicating and delaying the credit application process.

From the perspective of credit card providers, identifying potential customers for these promotions can be a large and costly process. The credit card providers traditionally “pre-screen” large groups of potential customers in order to identify a subset of potential customers who are most likely to respond to or qualify for a particular promotion. This is a “shotgun” approach, and—at best—results in a fairly small percentage of those targeted potential customers actually receiving, reviewing and responding to the promotion.

A more “rifle”-type approach is used by many merchants, who offer credit applications at their points-of-sale, often with a promotion for some percentage discount on purchases made that day with the new account. Although a credit account may be established fairly quickly through such means, these point-of-sale applications are traditionally full, customer-initiated applications, that not only require a completed form and information from the customer, but carry no guarantee that approval is likely. That is, there is no pre-screening performed prior to the customer's credit application.

Still another problem with traditional credit card application processes is the potential necessity for an applicant to make multiple applications with multiple lenders in order to obtain credit. As an example, if a consumer's application is declined for one credit card, the consumer generally must complete another application with another lender in order to obtain a credit card, and the new application similarly does not carry any guarantee of likely approval. Each of these applications can negatively affect the consumer's credit rating.

Others have attempted to address some of these problems. One method, described by Lebda et al. in U.S. Pat. Nos. 6,385,594 and 6,611,816, uses a web browser interface to allow an applicant to submit a loan application to a central source. The central source obtains credit information regarding the applicant and compares it to selection criteria provided by a number of participating lenders. The applicant is presented with a choice of those lenders whose selection criteria were satisfied. This method has several shortcomings, particularly with respect to credit card applications: It is initiated by the applicant, so a lender cannot proactively target a customer. It is not performed at a point-of-sale, so a customer may be less receptive to an isolated offer for credit than an offer made during an actual purchase. Also, the applicant may be presented with a myriad of lender options, through which he must understand various differences in the individual terms in order to find an appropriate selection for him.

Another attempt to solve some of these problems involves the use of an automobile dealership's computer to automatically transmit an applicant's auto loan application to one or more lenders, as described by DeFrancesco et al. in U. S. Patent No. 5,878,403. The dealership selects a number of lenders it believes may likely approve the loan application, and also selects criteria to use to determine when applications should be automatically transmitted. Again, this method has several shortcomings as applied to the field of credit card applications. First, there is no pre-screening process, so it is not known if the applicant is “pre-approved” for a loan from a particular lender. Second, it is the responsibility of the dealer to choose which lenders should receive the application, and when. This manual selection may result in an oversight of the best lender for the applicant. Lastly, because the dealer determines how the loan application is distributed, there are no opportunities for synergies between compatible lenders, so that, for example, a lender specializing in less risky applicants can pre-arrange (via, e.g., a prior business transaction) to pass its declined applications to a lender more accepting of risky applicants.

### BRIEF SUMMARY OF THE INVENTION

Embodiments of the invention are used for targeting customers with offers for pre-approved credit cards. Some embodiments can be employed while the customer is engaged in a business transaction at a merchant's point-of-sale by pre-screening for creditworthiness using basic customer information known to the merchant. The pre-screening can be performed on behalf of a single lender or in a cascading fashion on behalf of multiple lenders should the customer fail initial pre-screens. In some embodiments, a cascading approach is used to process customer-initiated credit card applications, such that an applicant declined credit from one lender is automatically considered for credit from another lender via an arrangement between the lenders.

Embodiments of the invention thus hold numerous advantages over previously existing methods, which did not target individual customers with pre-approved credit offers at a point-of-sale, and which did not use a lender-cooperative approach to allow one lender's declining of an applicant or prospective applicant to be passed to another lender for consideration. Embodiments of the present invention overcome these shortcomings.

In one aspect of the invention, a method is provided for providing a consumer with an offer to establish a pre-approved line of credit from one of a plurality of lenders, the method comprising obtaining basic information on the consumer, the basic information comprising the consumer's name and address, routing the basic information to a third party processor for pre-screening of the consumer in a manner previously arranged between the plurality of lenders, receiving from the third party processor an indication that the consumer is pre-approved to establish a line of credit with at most one lender from the plurality of lenders, and informing the consumer of said pre-approval.

In another aspect, a method is provided for selecting one of a plurality of lenders to extend an offer for a line of credit to a consumer, the method comprising querying one or more credit bureau reporting agencies for a response indicating whether the consumer satisfies pre-screening criteria previously provided by a first lender from the plurality of lenders, if the consumer meets the first lender's pre-screening criteria, then transmitting an indication that the consumer is pre-approved to establish a line of credit with the first lender, if the consumer does not meet the first lender's pre-screening criteria, then querying one or more credit bureau reporting agencies for a response indicating whether the consumer satisfies pre-screening criteria previously provided by a second lender from the plurality of lenders, and if the consumer meets the second lender's pre-screening criteria, then transmitting an indication that the consumer is pre-approved to establish a line of credit with the second lender, wherein the first lender and second lender have together previously arranged for the method to be applied.

In yet another aspect, a method is provided for processing an applicant's application for credit, the method comprising processing the application for a first lender, if the applicant does not meet the first lender's acceptance criteria, then facilitating a pre-screen of the applicant on behalf of a second lender by using screening criteria provided by the second lender, and if the pre-screen is successful, then identifying the applicant to the second lender.

In still another aspect, a method is provided for targeting an individual consumer with an offer for a pre-approved credit card during a business transaction with a merchant at a point-of-sale, the method comprising obtaining basic information on the consumer, the basic information comprising the consumer's name and address, routing the basic information to a third party processor for pre-screening of the customer on behalf of a first lender, receiving from the third party processor an indication of pre-approval for the consumer, and presenting an offer to the consumer to apply for a credit card during the course of the business transaction.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a general overview of the operation of a method and system contemplated by an embodiment of the present invention;

FIG. 2 is a general overview of the operation of a method and system contemplated by an embodiment of the present invention;

FIG. 3 is a flow diagram illustrating a method of providing a point-of-sale pre-screen for potential credit card applicants using a cascading method, in accordance with an embodiment of the invention;

FIG. 4 is a flow diagram illustrating details of a cascading method of finding a suitable lender for a potential credit card applicant, in accordance with an embodiment of the invention; and

FIG. 5 is a flow diagram illustrating a cascading method of finding a suitable lender for a credit card applicant, in accordance with an embodiment of the invention.

### DETAILED DESCRIPTION OF THE INVENTION

The following examples further illustrate the invention but, of course, should not be construed as in any way limiting its scope.

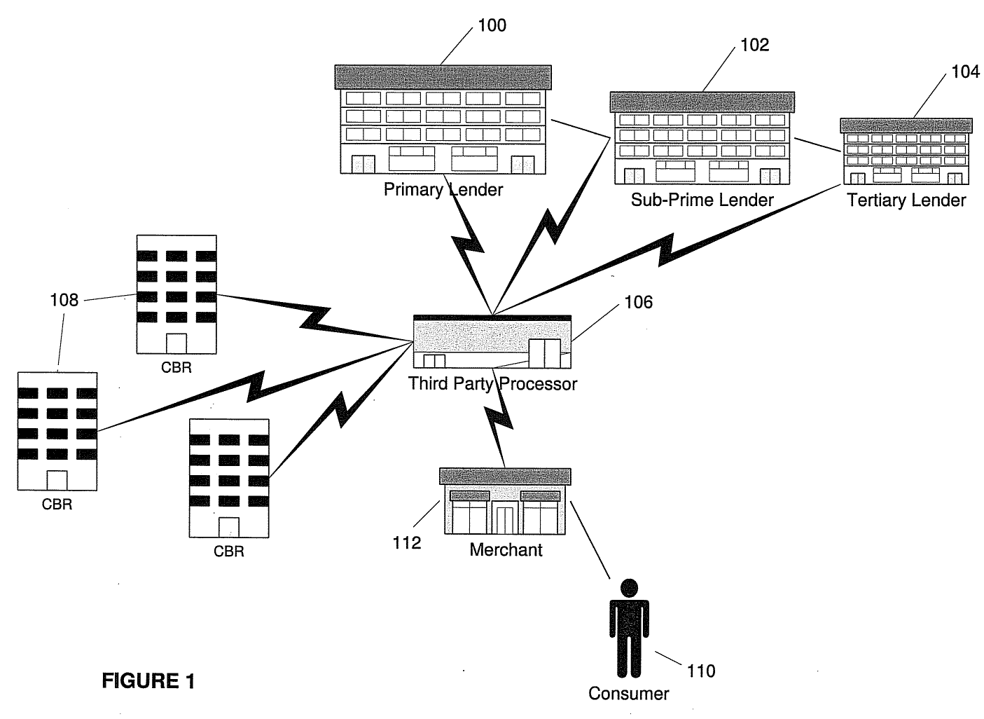

Turning to FIG. 1, an implementation of a cascading credit application system contemplated by an embodiment of the invention is shown with reference to an overall credit card application environment. A primary lender 100, secondary lender 102 and tertiary lender 104 each provides credit cards to consumers, at varying rates of interest and conditions. For example, the primary lender 100 can be a large bank that lends with favorable interest rates to only the most creditworthy customers; the secondary lender 102 can be a bank that lends at higher rates of interest to riskier customers; the tertiary lender 104 can be a bank that specializes in lending to the riskiest and least creditworthy customers at still higher rates of interest. Because of their segmented target markets, the three lenders might not be in direct competition for at least some classes of customers. As such, there are opportunities for business partnering relationships between the three lenders.

In the example of FIG. 1, applications for credit are handled by a third party processor 106. An example of such a third party processor is Financial Networks, Inc. (FNI), although a separate entity third party processor is not required. In other words, the functions of the third party processor described herein alternatively can be performed by the merchant, the credit bureau reporting agency, one of the lenders or some other entity or combination of entities. Generally, the third party processor 106 is able to perform two types of inquiries with respect to processing a credit application. A “pre-screen” or “promotional inquiry” can be performed without the knowledge of the customer based on limited information. Pre-screens are often useful in initially identifying target customers, and do not affect a customer's credit rating. Using the results of a pre-screen, a lender typically informs a potential customer that he has been “pre-approved” and, often via a promotional mailing, offers a promotion if the customer applies for a credit card.

While a pre-screen helps identify potential customers, it may not provide sufficient information to a lender in order to determine definitively whether to book a line of credit for a particular customer. Thus, the second type of inquiry—a “hard inquiry” or “consumer initiated inquiry”—may be necessary in order to obtain more detail about the customer's financial status (e.g., income). A hard inquiry must be performed if a customer knowingly applies for credit, and the inquiry itself generally affects the customer's credit rating.

The third party processor 106 acts on the behalf of the primary lender 100, secondary lender 102 and/or tertiary lender 104 to process applications for credit or promotional offers. The third party processor 106 in part uses information from credit reporting bureaus 108, such as Experian, Equifax and TransUnion. The third party processor 106 also preferably accepts specified criteria from lenders, to which it screens the information from the credit bureau reporting agencies 108. Alternatively, the pre-screen criteria for the respective lenders may reside at one or more of the credit reporting bureaus, in which case the third party processor would initiate the pre-screen, but the pre-screen function itself would be performed by the credit reporting bureau. In traditional credit application systems, the third party processor 106 or the credit reporting bureau 108 performed such screening on behalf of only a single lender, and screening decisions with respect to one lender were not coordinated with screening decisions of another lender. In some embodiments of the present invention, the third party processor 106 coordinates screening between more than one lender, so that if a customer fails a pre-screen for a primary lender's 100 screening criteria, he is subsequently screened against the secondary lender's 102 criteria, for example.

In accordance with an embodiment of the invention, a process is provided allowing a customer to be presented with an offer of pre-approved credit from one of a number of lenders during the course of a transaction with a merchant. As shown in FIG. 1, a customer 110 is engaged in a business transaction for goods or services with a merchant 112. In the course of the transaction, the customer 110 provides some basic information to the merchant, such as his name and address. Alternatively, the merchant 112 obtains this basic information from its own internal database. The merchant 112 forwards the information to the third party processor 106, which executes a pre-screen for the customer 110 according to the primary lender's criteria by communicating with the credit bureau reporting agencies. If the customer 110 passes the pre-screen, the third party processor 106 informs the merchant 112 that the customer 110 meets the primary lender's 100 criteria. If the customer 110 fails, the third party processor 106 then pre-screens the customer 110 according to the criteria of secondary lender 102. If the customer 110 fails this pre-screen, then the third party processor 106 pre-screens the customer 110 according to the criteria of tertiary lender 104. The third party processor 106 can continue in this coordinated manner, pre-screening according to a number of lenders' criteria until it passes. Once a customer 110 satisfies the pre-screen criteria for some lender, that lender is identified to the merchant 112 along with instructions to inform the customer 110 that he has been pre-approved for credit from that lender. In this manner, the customer 110 receives an offer from only one lender.

The customer 110 then can decide if he wishes to apply for credit from the identified lender. If so, then the customer 110 provides to the merchant 112 any additional information necessary, such as date of birth and social security number, and the information is passed along to the third party processor 106, which performs a hard inquiry and screens against the lender's provided criteria. Alternatively, if a hard inquiry has recently been performed on the customer 110, then those previous inquiry results are still considered current by the third party processor 106, and no hard inquiry is performed at this time. If the inquiry is successful, the merchant 112 is notified along with instructions to inform the customer 110 that he has been approved, and, a line of credit is thereafter established for the customer 110. In some embodiments of the invention, the line of credit is available for use on the very transaction in which the customer 110 and merchant 112 are presently engaged. Alternatively, the line of credit is noted as the account to be used for a recurring bill from the merchant 112, such as a monthly payment for a service provider. If necessary, a fulfillment kit is sent to the customer via mail or delivered electronically prior to activating the line of credit and/or associated credit card.

More generally, in some embodiments of the invention a variation of the process described above is used to pre-screen an individual customer 110 at a merchant 112 point-of-sale for a single lender 100, without necessarily using any cascade or arrangement with additional lenders 102 and 104. In previously practiced processes, pre-screening was traditionally performed as a batch process on a large set of potential customers in order, for example, to identify those potential customers most likely to respond to a particular promotion offered by a lender. The batch process was traditionally initiated by the lender 100 and did not involve any merchant 112 at any point-of-sale. In some embodiments of the invention, however, the pre-screen is performed for a single customer 110 who is presently engaged in a transaction with a merchant 112. The process can be initiated by the merchant 112, who provides the customer's 110 name and address to the lender 100 or third party processor 106. Such a pre-screening process for an individual customer 110 allows that customer 110 to be targeted with a particular offer at a precise moment when the offer may be most well-received by him (i.e., when he is engaged in a financial transaction that could benefit from the offer). Furthermore, if the cascading approach is used with additional lenders 102 and 104, then an individual offer can be even more finely tailored to suit the particular customer 110. This provides an advantage over prior batch processes for the bulk pre-screening of potential customers, who may not receive a customized offer, or who may easily disregard a promotional offer that arrives via mail.

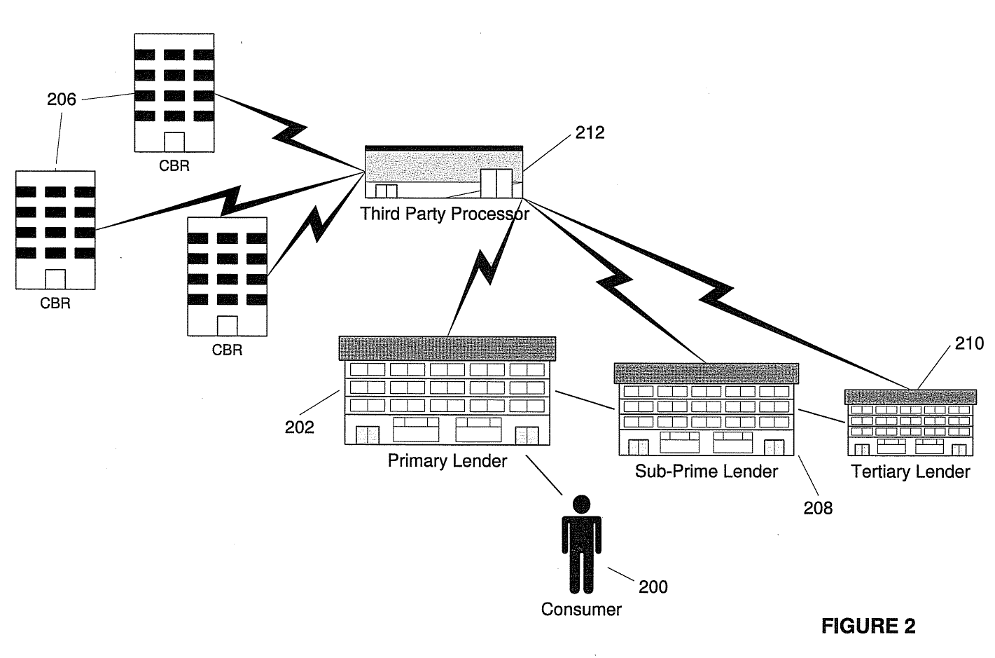

In accordance with another embodiment of the invention, a process is provided for allowing an applicant for a first credit card to be accepted for an alternative credit card when his application for the first card is declined. As described with respect to FIG. 2, an applicant 200 applies for credit directly with the primary lender 202. The primary lender 202 discloses to the applicant, preferably on the application 204 itself, that it can or that it intends to pass the application to a partner lender should the application be declined. The applicant's 200 personal information from the application 204 is passed in a batch operation for hard inquiry to the credit reporting bureaus 206, which respond by providing detailed financial information about the applicant 200 to the lender 202. The primary lender 202 has previously arranged with partner secondary lender 208 that each received application should be compared to particular criteria and threshold levels in order to allow the application to be approved by either the primary lender 202 or the secondary lender 208, but not both. For example, the primary lender 202 and secondary lender 208 have agreed that any applicant's application for which the applicant's FICO score is within a first range should be declined by the primary lender 202 and instead routed to the secondary lender 208 for approval. Other criteria, such as whether the applicant is a homeowner, has a certain level income or occupation, or is an existing customer of one or more of the lenders, can be used in addition or in place of a FICO score range. Similarly, more than two lenders can arrange for a function to be applied so that an applicant's 200 application 204 can be routed to a tertiary lender 210 should the applicant's financial information fail particular criteria. For example, if an applicant's FICO score is within a second range, the applicant's application 204 will be declined by the primary lender 202, declined by the secondary lender 208, and instead by routed to the tertiary lender 210. Ordinarily, no information is passed from one lender to another regarding why an application is now passed to it by another lender. In this way, the primary lender 202 receives all applications meeting its criteria, the secondary lender 208 receives all those applications potentially meeting its criteria but failing the primary lender's 202 criteria, and the tertiary lender 210 receives all those applications potentially meeting its criteria but failing the primary lender's 202 and the secondary lender's 208 respective criteria. Meanwhile, the applicant 200 will be approved for credit with the partner lender for which he is maximally qualified. Other arrangements are possible, and many are described below. In some embodiments, a third party processor 212 is used for processing the application 204 and for executing other parts of the process on behalf of the primary lender 202.

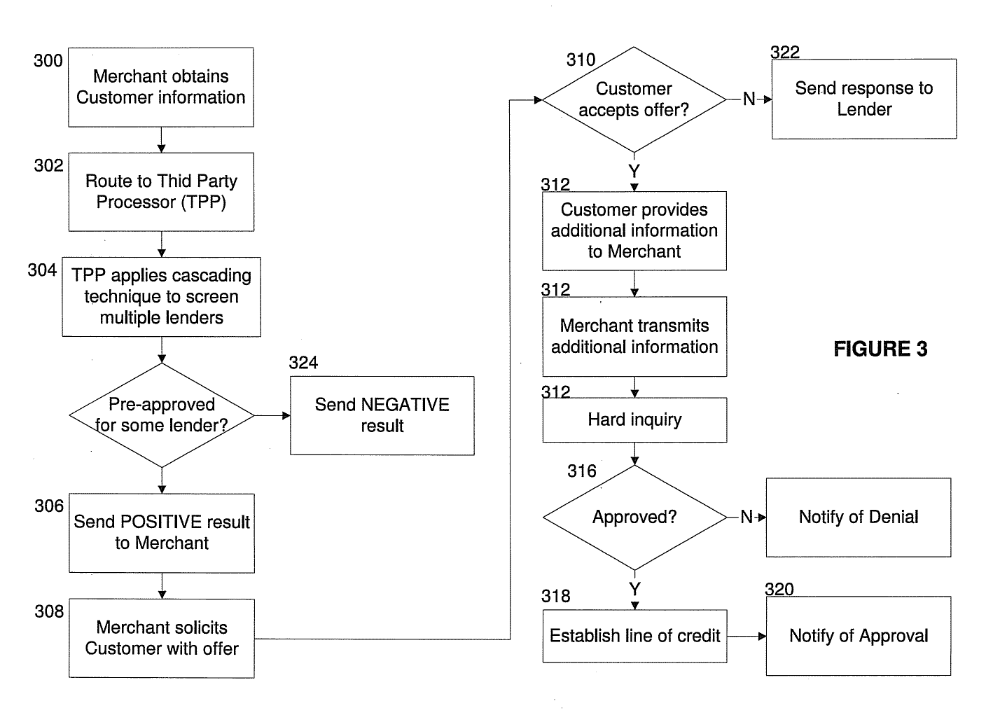

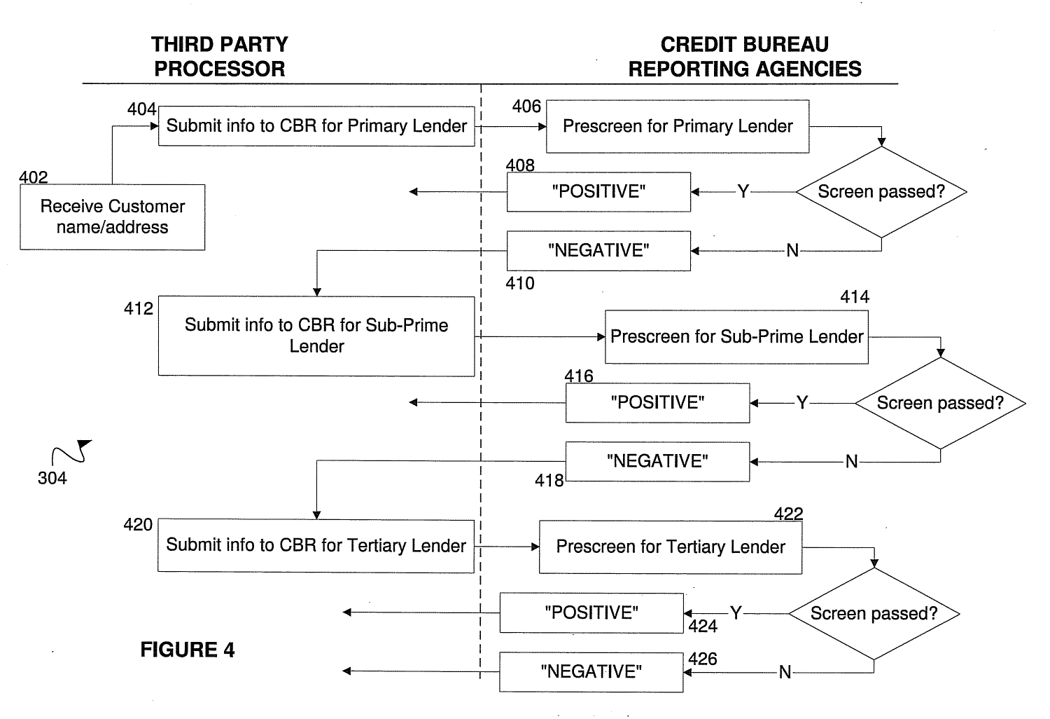

Turning to FIG. 3, a flow diagram is shown illustrating a method of pre-screening a customer for a plurality of credit applications in a cascading fashion, in accordance with an embodiment of the invention. During the course of a transaction with a merchant at a point-of-sale (including online sales), the merchant obtains the customer's name and address at step 300. This can be achieved in any number of ways, including, but not limited to, lookup in an internal database of the merchant (with data collected, for example, during previous transactions between the customer and the merchant), entry by the customer into a written or online form, or the merchant verbally asking the customer for the information. The merchant routes this information to a third party processor at step 302. In some embodiments of the invention, the merchant and third party processor communicate over an Internet connection through a web interface. This web interface can be a web page provided by the third party processor to accept as input a customer's name and address, or a system-to-system secure data transmission over the Internet from the merchant's internal database to the third party processor, or another method of secure Internet transmission not specifically mentioned heretofore. Additionally, in some embodiments the information is routed over the transaction network itself. The third party processor has previously arranged with multiple lenders to process pre-screens. The third party processor uses the name and address information provided by the merchant to iteratively query one or more credit bureau reporting agencies according to the pre-screen criteria of the respective lenders in a cascading fashion at step 304, described more fully below with respect to FIG. 4. If the cascading process results in a determination that the customer is pre-approved for credit from a lender, then at step 306 a “Positive” result is sent back to the merchant, indicating which lender has pre-approved the customer for credit. Additionally, the third party processor can use lender-provided criteria to identify a promotional offer to be given to the customer, such as, for example, a lower initial rate of interest. The merchant then solicits the customer at step 308, informing him that he has been pre-approved for a credit card from the identified lender and preferably communicating any offered promotion, and asking him if he wishes to apply for a credit card from the lender. The customer chooses whether to apply for the card at step 310. If so, then the customer provides to the merchant at step 312 standard necessary information to complete the application. This standard information may include, for example, the customer's date of birth and social security number. If the customer does not accept the offer at step 310, then the response can be sent back to the specified lender at step 322 for marketing purposes. Following a hard inquiry at step 314, a decision is made whether to approve the application at step 316, and a line of credit is established for the customer at step 318, preferably with an associated credit card account number. The approval is communicated to the customer via the merchant at step 320. In some embodiments, the credit account is available for immediate use.

If the customer's information does not meet the pre-screening criteria of any participating lender in the cascading process of step 304, then a “Do Not Offer” result is sent back to the merchant at step 324, who can continue the transaction in a normal manner. The “Do Not Offer” result can be sent for additional reasons such as, for example, if the customer has previously opted-out of receiving promotional offers.

In some embodiments of the invention, prior to the cascading process of step 304, the third party processor looks up the customer in its own internal database to determine whether that customer should be screened and solicited. For example, if the customer has been solicited many times in a certain time period, or has made a non-solicitation request, then the cascading process is not applied and the customer is not solicited.

In some embodiments of the invention, only one lender is used in the pre-screening process, so that the process of step 304 comprises only a single inquiry to one or more credit bureau reporting agencies on behalf of only one lender. In such embodiments, no cascading or arrangements between the primary lender and the secondary or tertiary lenders necessarily takes place.

In some embodiments, one or more incentives are provided to merchants to participate in the process. For example, the merchants can be paid a bounty for every customer they identify that results in a line of credit being established for that customer. As another example, participating merchants are offered a discounted rate from a credit card company. As another example, merchants are advised that lenders will give customers incentives (including, but not limited to, lower financing rates, points in affinity programs, etc.) to make purchases at those merchants

With reference to FIG. 4, the cascading process of step 304 is described in greater detail, in accordance with an embodiment of the invention. The process begins with a third party processor taking as input a customer's name and address at step 402. The third party processor has previously arranged with a plurality of lenders to apply an agreed-upon cascading method. The third party processor first submits at step 404 the customer's name and address to a credit bureau reporting agency (CBR), along with the subscriber code for a primary lender. The CBR performs a pre-screen using the customer's financial data and the lender's criteria at step 406. If the customer passes the lender's criteria, a “Positive” response is sent to the third party processor at step 408, indicating the customer passed the primary lender's pre-screen.

Otherwise, the CBR sends a “Do Not Offer” response to the third party processor at step 410. The third party processor submits to the CBR the customer's name and address and the subscriber code for the next lender in the cascading list, for example, a secondary lender at step 412. The CBR performs a pre-screen using the customer's financial data and the lender's criteria at step 414. If the customer passes the lender's criteria, a “Positive” response is sent to the third party processor at step 416, indicating the customer passed the secondary lender's pre-screen.

Otherwise, the CBR sends a “Do Not Offer” response to the third party processor at step 418. The third party processor submits to the CBR the customer's name and address and the subscriber code for the next lender in the cascading list, for example, a tertiary lender at step 420. The CBR performs a pre-screen using the customer's financial data and the lender's criteria at step 422. If the customer passes the lender's criteria, a “Positive” response is sent to the third party processor at step 424, indicating the customer passed the tertiary lender's pre-screen. Otherwise, the CBR sends a “Do Not Offer” response to the third party processor at step 426.

Many variations of the cascade are possible within embodiments of the inventions. For example, in some embodiments, the cascading process continues if the customer fails the tertiary lender's pre-screen by pre-screening against additional lenders. In some embodiments, only two lenders participate in the cascading process. In further embodiments, multiple lenders participate in a level of the cascade so that, for example, some percentage (e.g., 70%) of customers failing the primary lender pre-screen are then pre-screened against criteria of one secondary lender, while another percentage (e.g., 30%) of such customers are pre-screened against criteria of a second secondary lender. In another variation, more than three lenders participate in the cascading process.

By using the cascading process for pre-screening applicants, as described in FIGS. 3 and 4, a customer is offered a pre-approved application for a line of credit from a single lender. The cascading arrangement between a group of lenders can be such that the single offer presented to the potential applicant contains the most favorable terms among the lenders' possible offers for which he qualifies. His choice is a simple “Yes” or “No”, and he does not need to wade through multiple offers from multiple lenders. The customer is further likely to have an increased chance of final approval of his credit application than in existing methods because of the close proximity in time between the pre-screen and the application itself—there is little chance for any intervening activity to occur that might negatively affect the application.

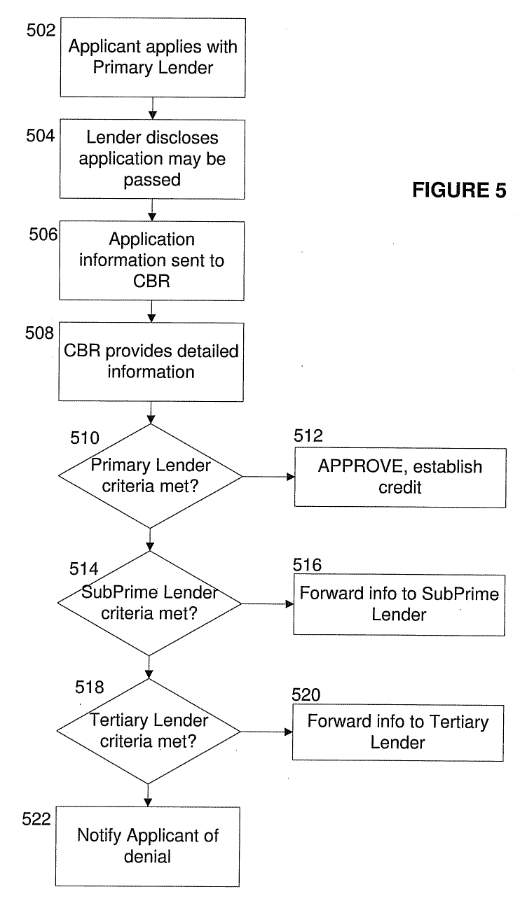

Turning to FIG. 5, a flow diagram is shown illustrating a cascading process used when an applicant applies for credit from a primary lender, in order to allow the application to be processed by a secondary lender, in accordance with an embodiment of the invention. At step 502, the applicant applies with a primary lender for a credit card. Unlike the examples of FIGS. 3 and 4, the process here involves an actual application for credit by an applicant, rather than a pre-screen initiated by a lender. The application can take the form of a traditional paper application, an online form, a telephone conversation with a customer representative, or other suitable medium. During the application process, at step 504 the lender discloses to the applicant that the application may be passed to partner lenders for processing should the lender decline the application. Alternatively, the lender asks the applicant if he wishes for his application to be passed to partner lenders in such an event. Preferably by using a third party processor, information from the completed application is sent to one or more credit bureau reporting agencies at step 506. The credit bureau reporting agencies return detailed credit history information regarding the applicant at step 508. By comparing the returned information against specific criteria, the primary lender is able to make a decision on the application at step 510. If the applicant meets the criteria, the primary lender can approve the application and establish a line of credit for the applicant at step 512. A fulfillment kit can be sent to the applicant if necessary.

Otherwise, the returned information is compared to criteria specific to a secondary lender at step 514. If the applicant meets the criteria for the secondary lender, then basic information about the applicant (e.g., name and address) is forwarded to the secondary lender for pre-screening at step 516, preferably with a notice that the applicant has met their screening criteria. At this time the secondary lender may obtain credit history information and make a decision on the application. Although current industry customs and practices prevent the reselling or sharing between lenders of applicant data other than name and address, should such reselling or sharing be allowed in the future then the process can be modified to allow the sharing of additional information. Alternatively, the third party processor sends the basic applicant information to the credit bureau reporting agencies for pre-screening on behalf of the secondary lender.

If the applicant does not pass the pre-screen of the secondary lender, then the returned information is compared to criteria specific to a tertiary lender at step 518. If the applicant meets the criteria for the tertiary lender, then basic information about the applicant is forwarded to the tertiary lender for pre-screening at step 520, preferably with a notice that the applicant has met their screening criteria. At this time the tertiary lender may obtain credit history information and make a decision on the application. Alternatively, the third party processor sends the basic applicant information to the credit bureau reporting agencies for pre-screening on behalf of the tertiary lender. If the applicant does not meet the pre-screening criteria for the tertiary lender, then the applicant is notified at step 522 that his application has been declined.

Numerous variations are possible within the general process of FIG. 5. For example, additional or fewer lenders may participate in the process. Additionally, although the secondary or tertiary lenders might only receive the name and address of an applicant via the cascading process, the secondary or tertiary lender can match this name and address to any internal database it may have for prospective customers, and in that manner obtain detailed information without inquiring of a credit bureau reporting agency.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for providing a consumer with an offer to establish a pre-approved line of credit from one of a plurality of lenders, the method comprising:
obtaining basic information on the consumer, the basic information comprising the consumer's name and address;
routing the basic information to a third party processor for pre-screening of the consumer in a manner previously arranged among the plurality of lenders;
receiving from the third party processor an indication that the consumer is pre-approved to establish a line of credit with at most one lender from the plurality of lenders; and
informing the consumer of said pre-approval.

2. The method of claim 1 wherein the manner of pre-screening comprises the steps of:
querying one or more credit bureau reporting agencies for a response indicating whether the consumer satisfies the pre-screening criteria of a first lender; and
if the consumer meets the first lender's pre-screening criteria, then transmitting an indication that the consumer is pre-approved to establish a line of credit with the first lender.

3. The method of claim 2 wherein the manner of pre-screening further comprises the steps of:
if the consumer does not meet the first lender's pre-screening criteria, then querying one or more credit bureau reporting agencies for a response indicating whether the consumer satisfies the pre-screening criteria of a second lender; and
if the consumer meets the second lender's pre-screening criteria, then transmitting an indication that the consumer is pre-approved to establish a line of credit with the second lender.

4. The method of claim 1 wherein the pre-screening occurs without the knowledge of the consumer.

5. The method of claim 1 wherein the method is initiated and completed during the course of a business transaction between the consumer and a merchant.

6. The method of claim 5 further comprising the steps of:
inviting the consumer to apply for a line of credit from said first lender;
receiving additional information from said consumer, including the consumer's social security number;
routing the additional information to said third party processor; and
receiving an indication from said third party processor whether said line of credit from said first lender is approved.

7. A method for selecting one of a plurality of lenders to extend an offer for a line of credit to a consumer, the method comprising:
querying one or more credit bureau reporting agencies for a response indicating whether the consumer satisfies pre-screening criteria previously provided by a first lender from the plurality of lenders;
if the consumer meets the first lender's pre-screening criteria, then transmitting an indication that the consumer is pre-approved to establish a line of credit with the first lender;
if the consumer does not meet the first lender's pre-screening criteria, then querying one or more credit bureau reporting agencies for a response indicating whether the consumer satisfies pre-screening criteria previously provided by a second lender from the plurality of lenders; and
if the consumer meets the second lender's pre-screening criteria, then transmitting an indication that the consumer is pre-approved to establish a line of credit with the second lender;
wherein the first lender and second lender have together previously arranged for the method to be applied.

8. The method of claim 7 further comprising:
if the consumer does not meet the second lender's pre-screening criteria, then querying one or more credit bureau reporting agencies for a response indicating whether the consumer satisfies pre-screening criteria previously provided by a third lender from the plurality of lenders; and
if the consumer meets the third lender's pre-screening criteria, then transmitting an indication that the consumer is pre-approved to establish a line of credit with the third lender;
wherein the first, second and third lenders have together previously arranged for the method to be applied.

9. The method of claim 7 wherein the method is performed while the consumer is engaged in a retail transaction with a merchant.

10. The method of claim 9 wherein any line of credit established via the method is available for use with the retail transaction.

11. A method of processing an applicant's application for credit, the method comprising:
processing the application for a first lender;
if the applicant does not meet the first lender's acceptance criteria, then facilitating a pre-screen of the applicant on behalf of a second lender by using screening criteria provided by the second lender; and
if the pre-screen is successful, then identifying the applicant to the second lender.

12. The method of claim 11 wherein facilitating the pre-screen comprises comparing information provided by the applicant according to the screening criteria provided by the second lender.

13. The method of claim 11 wherein facilitating the pre-screen comprises instructing one or more credit bureau reporting agencies to pre-screen the applicant with a subset of the information provided by the applicant and the screening criteria provided by the second lender, on behalf of the second lender.

14. The method of claim 11 further comprising:
if the pre-screen for the second lender is not successful, then facilitating a pre-screen on behalf of a third lender by using screening criteria provided by the third lender; and
if the pre-screen for the third lender is successful, then identifying the applicant to the third lender.

15. A method for targeting an individual consumer with an offer for a pre-approved credit card during a business transaction with a merchant at a point-of-sale, the method comprising:
obtaining basic information on the consumer, the basic information comprising the consumer's name and address;
routing the basic information to a third party processor for pre-screening of the customer on behalf of a first lender;
receiving from the third party processor an indication of pre-approval for the consumer; and
presenting an offer to the consumer to apply for a credit card during the course of the business transaction.

16. The method of claim 15 wherein the basic information is obtained by the merchant prior to the present business transaction.

17. The method of claim 15 further comprising the steps of:
receiving an acceptance of the offer from the consumer;
transmitting additional consumer information to the third party processor;
receiving notification that the application has been approved.

18. The method of claim 17 further comprising the step of issuing a credit card account number for the consumer, wherein the credit card account number is available for use with the business transaction at the point-of-sale.

19. The method of claim 15 wherein the offer is to apply for a credit card issued by the first lender.

20. The method of claim 15 wherein the offer is to apply for credit card issued by a second lender if the consumer fails the first lender's pre-screen.
